(19) United States
(12) Patent Application Publication
(10) Pub. No.: US 2024/0177045 A1
(43) Pub. Date: May 30, 2024

(54) METHOD FOR DETERMINING DECOHERENCE MODEL OF QUBIT AND COMPUTER READABLE STORAGE MEDIUM

(71) Applicant: Alibaba Damo (Hangzhou) Technology Co., Ltd., Hangzhou (CN)

(72) Inventors: Feng WU, Hangzhou (CN); Tenghui WANG, Hangzhou (CN); Gengyan ZHANG, Hangzhou (CN); Hantao SUN, Hangzhou (CN); Tian XIA, Hangzhou (CN); Jianjun CHEN, Hangzhou (CN); Huihai ZHAO, Beijing (CN)

(21) Appl. No.: 18/523,028

(22) Filed: Nov. 29, 2023

(30) Foreign Application Priority Data
Nov. 30, 2022 (CN) 202211520114.X

(51) Int. Cl. G06N 10/40; G06N 10/70

(52) U.S. Cl. CPC G06N 10/40; G06N 10/70

(57) ABSTRACT

The present disclosure discloses method for determining decoherence model of qubit and computer readable storage medium. The method relates to the technical field of and quantum, including: acquiring decoherence measurement data obtained by performing decoherence measurement on the qubit; determining a plurality of type-parameter combinations, the type-parameter combinations that includes combinations of model types and model parameters; determining candidate decoherence models corresponding to the plurality of type-parameter combinations based on the decoherence measurement data; and determining a target decoherence model from the candidate decoherence models corresponding to the plurality of type-parameter combinations. According to the present disclosure, the technical problem of inaccurate prediction occurs when the decoherence time of the qubit is predicted by adopting the decoherence model in the conventional technology is solved.

### CROSS-REFERENCE TO RELATED APPLICATIONS

The disclosure claims the benefits of priority to Chinese Application No. 202211520114.X, filed on Nov. 30, 2022, which is incorporated herein by reference in its entirety.

### TECHNICAL FIELD

The present disclosure relates to the field of quantum technology, and specifically relates to a method for determining decoherence model of qubit and computer readable storage medium.

### BACKGROUND OF THE DISCLOSURE

In the measurement of a qubit, the decoherence time of the qubit is a key parameter of the qubit. In the conventional technology, in order to acquire the decoherence time of the qubit, a decoherence model is generally adopted for prediction. However, the premise of adopting the decoherence model for prediction is to acquire a relatively accurate decoherence model. At present, the decoherence model is always obtained based on theoretical deducing, for example, some physical quantities related to the decoherence time are deduced through experience, and then some mathematical models are constructed based on the physical quantities, so that the decoherence model is obtained. However, there is still a problem of inaccurate prediction when the decoherence time of the qubit is predicted by adopting the decoherence model which is completely deduced based on theory in the conventional technology.

### SUMMARY

The disclosed embodiments of the present disclosure provide a method for determining decoherence model of qubit and a computer readable storage medium, aiming at solving the technical problem of the inaccurate prediction when the decoherence time of the qubit is predicted by adopting the decoherence model which is completely deduced based on theory in the conventional technology.

According to some embodiments of the present disclosure, a method is provided for determining a decoherence model of a qubit. The method includes: acquiring decoherence measurement data obtained by performing decoherence measurement on the qubit; determining a plurality of type-parameter combinations that includes combinations of model types and model parameters; determining candidate decoherence models corresponding to the plurality of type-parameter combinations based on the decoherence measurement data; and determining a target decoherence model from the candidate decoherence models corresponding to the plurality of type-parameter combinations.

In some embodiments, acquiring decoherence measurement data obtained by performing decoherence measurement on the qubit includes: in a case that the decoherence measurement includes depolarization measurement or dephasing measurement, acquiring depolarization measurement data obtained by performing depolarization measurement on the qubit; or acquiring dephasing measurement data obtained by performing dephasing measurement on the qubit, the decoherence measurement data including the depolarization measurement data or the dephasing measurement data.

In some embodiments, acquiring a plurality of model types, and a plurality of model parameters includes: in a case that the decoherence measurement includes the depolarization measurement or the dephasing measurement, determining that the plurality of model types include an exponential type and a double exponential type corresponding to the depolarization measurement, and an exponential type and a Gaussian type corresponding to the dephasing measurement; and determining that the plurality of model parameters include property parameters of the qubit and environment parameters.

In some embodiments, determining a plurality of type-parameter combinations includes: acquiring a plurality of model types, and a plurality of model parameters; and combining the plurality of model types and the plurality of model parameters to obtain the plurality of type-parameter combinations.

In some embodiments, acquiring a plurality of model types, and a plurality of model parameters includes: acquiring the type of the qubit; and acquiring the plurality of model types and the plurality of model parameters based on the type of the qubit.

In some embodiments, determining candidate decoherence models corresponding to the plurality of type-parameter combinations based on the decoherence measurement data includes: for any type-parameter combination in the plurality of type-parameter combinations, acquiring a target model type of the any type-parameter combination and a target model parameter; determining a value of the target model parameter under the target model type based on the decoherence measurement data, so as to obtain a candidate decoherence model corresponding to the any type-parameter combination; and obtaining the candidate decoherence models corresponding to the plurality of type-parameter combinations by a mode of obtaining the candidate decoherence model corresponding to the any type-parameter combination.

In some embodiments, determining a value of the target model parameter under the target model type based on the decoherence measurement data, so as to obtain a candidate decoherence model corresponding to the any type-parameter combination includes: determining corresponding quantum states of the qubit at a plurality of time points based on the decoherence measurement data; based on the plurality of time points and the corresponding quantum states of the qubit at the plurality of time points, fitting a coherence curve; and determining a value of the target model parameter under the target model type based on the coherence curve, so as to obtain the candidate decoherence model corresponding to the any type-parameter combination.

In some embodiments, determining corresponding quantum states of the qubit at a plurality of time points based on the decoherence measurement data includes: correcting the decoherence measurement data to obtain corrected data; and determining the candidate decoherence models corresponding to the plurality of type-parameter combinations based on the corrected data.

In some embodiments, determining a target decoherence model from the candidate decoherence models corresponding to the plurality of type-parameter combinations includes: acquiring experimental measurement data from a decoherence measurement experiment on an experimental qubit; predicting a decoherence data of the experimental qubit by the candidate decoherence models corresponding to the plurality of type-parameter combinations respectively, so as to obtain corresponding prediction data; comparing the experimental measurement data with the prediction data of the candidate decoherence models corresponding to the plurality of type-parameter combinations respectively, so as to obtain comparison difference results; and selecting the candidate decoherence model with a minimum difference result from the comparison difference results as the target decoherence model.

In some embodiments, the qubit includes a Fluxonium qubit.

In some embodiments, after determining a target decoherence model from the candidate decoherence models corresponding to the plurality of type-parameter combinations, the method further includes: predicting a to-be-measured qubit by the target decoherence model, so as to obtain a decoherence time of the to-be-measured qubit.

According to some embodiments of the present disclosure, a method is provided for determining a decoherence model of a qubit. The method includes: displaying a data input control, a decoherence model display control and a decoherence model determination control on a display interface; in response to an operation on the data input control, receiving decoherence measurement data obtained after performing decoherence measurement on the qubit; in response to an operation on the decoherence model display control, displaying a plurality of candidate decoherence models on the display interface, the plurality of candidate decoherence models corresponding to a plurality of type-parameter combinations and being determined based on the decoherence measurement data, and the plurality of type-parameter combinations being determined based on a plurality of model types and a plurality of model parameters; and in response to an operation on the decoherence model determination control, displaying a target decoherence model determined from the candidate decoherence models corresponding to the plurality of type-parameter combinations on the display interface.

According to some embodiments of the present disclosure, a non-transitory computer readable storage medium is provided and includes stored programs. The programs, when run, control a device where the storage medium is located to execute any one of the abovementioned methods for determining the decoherence model of the qubit.

According to some embodiments of the present disclosure, a computer device is provided and includes a memory and a processor. The memory is configured to store a computer program. The computer program stored in the memory, when executed by the processor, cause the processor to execute any one of the abovementioned methods for determining the decoherence model of the qubit when the computer program is running.

### BRIEF DESCRIPTION OF THE DRAWINGS

The accompanying drawings described here are intended to provide a further understanding of the present disclosure, and constitute a part of the present disclosure. Illustrative embodiments of the present disclosure and descriptions thereof are intended to explain the present disclosure, and do not constitute an improper limitation on the present disclosure. In the accompanying drawings:

FIG. 1 is a hardware structure block diagram of an example computer terminal for implementing a method for determining a decoherence model of a qubit, according to some embodiments of this disclosure.

FIG. 2 is a flowchart of an example method for determining a decoherence model of a qubit, according to some embodiments of the present disclosure.

FIG. 3 is a flowchart of an example method for determining a decoherence model of a qubit, according to some embodiments of the present disclosure.

FIG. 4 is a flowchart of an example method for determining a decoherence model, according to some embodiment of the present disclosure.

FIG. 5 is a frame diagram of an example apparatus for determining a decoherence model of a qubit, according to some embodiments of the present disclosure.

FIG. 6 is a frame diagram of an example apparatus for determining a decoherence model of a qubit, according to some embodiments of the present disclosure.

FIG. 7 is a structure block diagram of an example computer device, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms or definitions incorporated by reference.

As stated above, there is there is still the technical problem of inaccurate prediction when the decoherence time of the qubit is predicted by adopting the decoherence model in the conventional technology. Embodiments of the present disclosure overcome this issue.

The acquisition of decoherence measurement data, obtained through the performance of decoherence measurement on the qubit, presents an opportunity to determine a plurality of type-parameter combinations. These combinations can include model types and model parameters. Subsequently, candidate decoherence models corresponding to the plurality of type-parameter combinations can be selected based on the decoherence measurement data. Through this process, the target decoherence model can be determined, thereby achieving the effects of reversely deducing model parameters of the decoherence models and selecting the most optimal model from the plurality of candidate decoherence models.

In essence, the embodiments of the present disclosure employ real and precise decoherence measurement data in determining the candidate decoherence models, affording a significant improvement in accuracy. Moreover, the selection of the target decoherence model from the plurality of candidate decoherence models ensures the optimization of the decoherence model, leading to a more accurate and refined outcome. As a result, the disclosed embodiments effectively tackle the technical problem of inaccurate prediction of the qubit's decoherence time, which is prevalent in conventional methods.

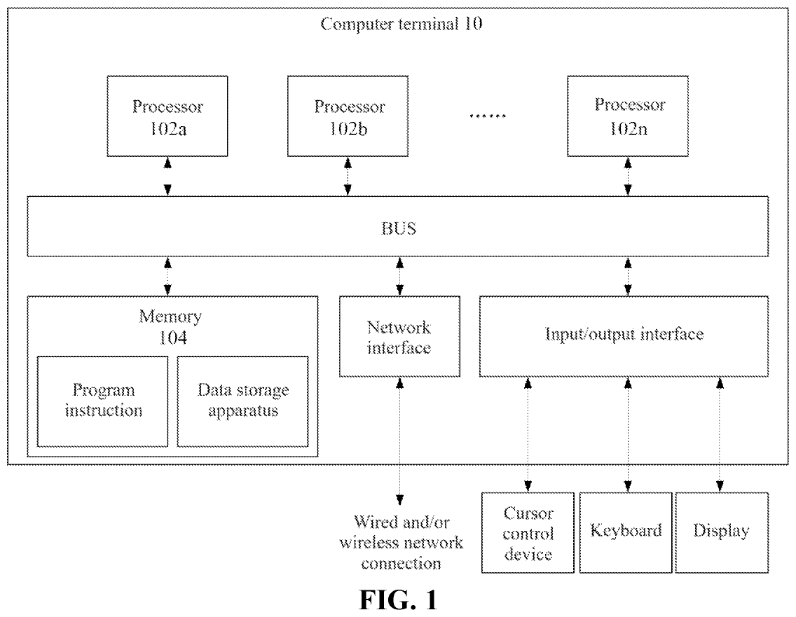

The example method provided by some embodiments of this disclosure may be implemented in a mobile terminal, a computer terminal or similar computing devices. FIG. 1 is a hardware structure block diagram of an example computer terminal for implementing a method for determining a decoherence model of a qubit, according to some embodiments of this disclosure.

As appreciated, the state of a bit is unique in a classical mechanics system, and quantum mechanics allows the qubit to be superposition of two states at the same moment, which is the basic property of quantum computing. Physically, the qubit is in a quantum state, so the qubit has the property of the quantum state. Due to the unique quantum property of the quantum state, the qubit has many characteristics that are different from classical bits, which is one of the basic characteristics of quantum information science.

As also appreciated, quantum coherence refers to that the states of electron right spinning and positron left spinning are associated. Quantum coherence is adopted to implement high-efficiency parallel operation in a quantum computer. And the qubits related to each other are connected in series to serve as an integral action. Therefore, as long as one qubit is processed, the influence will be immediately transmitted to redundant qubits in the series. This characteristic is the key for the quantum computer to carry out high-speed operation.

As also appreciated, decoherence is a process that the coherence of a quantum system is gradually lost over time in an open environment. Qubit decoherence is a process that the coherence of the qubit is lost over time.

As also appreciated, relaxation is a physical term, which refers to a process of gradually recovering from a certain state to an equilibrium state in a certain gradual change process. The required time is called relaxation time, and for the qubit, the relaxation time generally has two types, namely T1 and T2, T1 is spin-dot matrix or longitudinal relaxation time, and T2 is spin-spin or transverse relaxation time.

The qubit is composed of a two-energy-level system. The service life T1 of the qubit refers to a time that the qubit decays from a high energy level |1> to a low energy level |0>, namely (|1>)=e−t/T1. The qubit is prepared to be at the high energy level |1>, and under a condition that no gate operation is applied, the probability that the qubit is still in the |1> state is only 1/e≈0.37 after the time T1. The longer the elapsed time is, the lower the probability that the qubit is in the |1> state is, and the larger the caused computing error is. The longer the service life of the qubit is, the more the number of supported effective operations is, and complex computing may be completed. The T1 testing method is simple, generally, the qubit is prepared to reach the |1> state, waiting is conducted for a period of time t, the quantum state is measured to obtain the probability P(|1>) that the qubit is in the |1> state, then the waiting time t is gradually prolonged; and when P(|1>)=1/e, the corresponding waiting time t is T1.

The service life T1 of the qubit refers to the time of longitudinal relaxation of the quantum state, and the longitudinal relaxation will change the distribution probability of the qubit in the |0> state and the |1> state. The qubit also has a transverse relaxation, and the transverse relaxation does not change the probability of the quantum state, but will cause an angular shift of the quantum state in an xy plane of a Bloch sphere; and this angular shift finally will cause the qubit to degenerate from a coherent state to a mixed state, and such transverse relaxation time is represented by the qubit coherent time T2. T2 may be tested by the following method: initializing the qubit to |0> state; after a Hadamard gate operation, waiting for a period of time t, applying a Hadamard gate operation again, measuring the probability P(|0>) of the qubit in the |0> state, gradually prolonging the waiting time t; and when P(|0>)=1/e, obtaining the corresponding waiting time t that is T2.

As shown in FIG. 1, a computer terminal 10 may include one or more processors (shown in the figure as 102a, 102b . . . 102n, and the processors may include but be not limited to processing apparatuses such as a CPU, microprocessor MCU or a programmable logic device FPGA, an ASIC, a GPU, an NPU, or other data processing circuitry), a memory 104 configured to store data, and a transmission apparatus configured to perform a communication function. In addition, the processor may further include a display, an input/output interface (I/O interface) for communicating with I/O devices (e.g., cursor control device, keyboard, and display), a universal serial bus (USB) port (which may be included as one of the ports of a BUS), a network interface, a power supply or a camera. It is appreciated that the structure shown in FIG. 1 is only a schematic diagram and does not cause limitation to the structure of the electronic apparatus. For example, the computer terminal 10 may further include more or less components than those shown in FIG. 1, or has different configurations from those shown in FIG. 1.

It is be noted that the one or more processors or other data processing circuits may be generally called as a “data processing circuit” in this text. The data processing circuit may be completely or partially embodied as software, hardware, firmware or any other combination. In addition, the data processing circuit may be a single independent processing module or be completely or partially combined into any one of other elements in the computer terminal 10. As involved in the embodiment of the present disclosure, the data processing circuit serves as a processor control (such as selection of a variable resistance terminal path connected with the interface).

The memory 104 can be configured to store software programs of application software and modules, such as a program instruction/data storage apparatus corresponding to the searching method according to the embodiment of the present disclosure; and the processor executes various function applications and data processing by running the software programs and the modules stored in the memory 104, namely, a vulnerability detection method for the application programs is realized. The memory 104 can include a high-speed random access memory and can also include a nonvolatile memory, such as one or more magnetic storage apparatuses, flash memories or other nonvolatile solid-state memories. In the disclosed embodiments, the memory 104 can further include memories remotely arranged relative to the processor, and the remote memories may be connected to the computer terminal 10 through a network. The examples of the network include but are not limited to the Internet, an intranet, a local area network, a mobile communication network and a combination thereof.

The transmission apparatus is configured to receive or transmit data through a network. The specific examples of the network can include a wireless network provided by a communication provider of the computer terminal 10. In one example, the transmission apparatus includes a network interface controller (NIC), and the network interface controller can be connected with other network devices through a base station so as to communicate with the internet. In one example, the transmission apparatus may be a radio frequency (RF) module and is configured to communicate with the Internet in a wireless mode.

The display may be a touch screen type liquid crystal display (LCD) for example, and the liquid crystal display enables a user to interact with a user interface of the computer terminal 10.

It is to be noted that in some alternative embodiments, the computer device shown in FIG. 1 may include a hardware element (including a circuit), a software element (including computer codes stored on the computer readable medium) or a combination of the hardware element and the software element. It is to be pointed out that FIG. 1 is only one example of a specific example and aims at showing the type of components which can be in the computer device.

It is to be noted that in some embodiments, a computer device shown in FIG. 1 is provided with a touch display (also called as a “touch screen” or a “touch display screen”). In some embodiments, the computer device shown in FIG. 1 is provided with a graphic user interface (GUI); a user may perform human-computer interaction with the GUI through finger contact or gestures on the surface of the touch screen, and the human-computer interaction functions here may include the following interactions: creating a webpage, drawing, performing text processing, making an electronic document, playing a game, performing a video conference, performing instant messaging, receiving and sending an e-mail, making a call interface, playing a digital video, playing digital music or performing network browsing and the like. Executable instructions for executing the human-computer interaction functions are configured/stored in one or more processor executable computer program products or computer readable storage media.

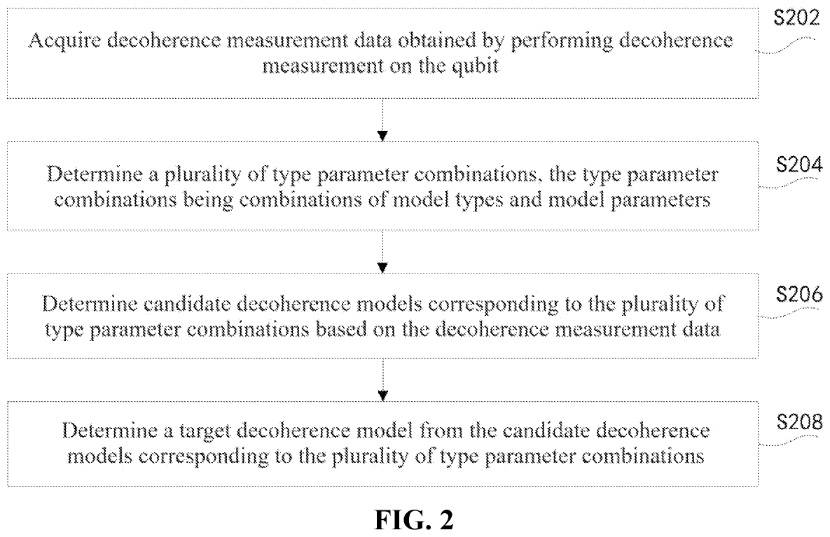

FIG. 2 is a flowchart of an example method for determining a decoherence model of a qubit, according to some embodiments of the present disclosure. As shown in FIG. 2, the method may include the following steps S202 to S 208. It is be noted that the steps shown in the flowchart of the accompanying drawings may be executed in a computer system such as a set of computer-executable instructions, and moreover, although a logical order is shown in the flowchart, in some cases, the steps shown or described may be performed in an order different from that shown or described herein.

In step S202, a computer device acquires decoherence measurement data obtained by performing decoherence measurement on the qubit.

In some embodiments, an execution entity of the method for determining the decoherence model of the qubit may be a terminal or a server. The terminal may be of a plurality of types, for example, a stationary computer or a mobile terminal; and the mobile terminal may be of a plurality of types, for example, a mobile phone and a Pad; and the server may be a separate computer or a computer group including a plurality of computers.

In some embodiments, the qubit may be of a plurality of types, for example, a Transmon qubit, a Fluxonium qubit, or other types of qubits.

In the present disclosure, transmon is a superconducting qubit type with a simple structure, and is composed of a small Josephson junction and a capacitor electrode. Fluxonium is a type of superconducting qubit, and is composed of a Josephson junction in parallel with an inductor and capacitor.

In some embodiments, when decoherence measurement is performed on the qubit, a plurality of types of decoherence measurement may be performed based on different physical quantities representing decoherence time. There may be a plurality of types of physical quantities for the decoherence measurement, for example, depolarization measurement T1 and dephasing measurement T2.

In some embodiments, acquiring decoherence measurement data obtained by performing decoherence measurement on the qubit may include: in a case that the decoherence measurement includes depolarization measurement or dephasing measurement, acquiring depolarization measurement data obtained by performing depolarization measurement on the qubit; or acquiring dephasing measurement data obtained by performing dephasing measurement on the qubit, the decoherence measurement data including the depolarization measurement data or the dephasing measurement data. That is, the depolarization measurement and the dephasing measurement in the decoherence measurement may be independently used for implementing the decoherence measurement, and may also be combined to implement the decoherence measurement.

In step S204, the computer device determines a plurality of type-parameter combinations, wherein the type-parameter combinations is the combinations of model types and model parameters.

In some embodiments, a plurality of models may be adopted during determining the plurality of type-parameter combinations, for example, a mode of acquiring a plurality of model types, and a plurality of model parameters; and then, determining the plurality of type-parameter combinations based on the plurality of model types and the plurality of model parameters;

In some embodiments, a plurality of models may be adopted during acquiring the plurality of model types, and the plurality of model parameters, for example, a mode of acquiring the type of the qubit; and then, acquiring the plurality of model types and the plurality of model parameters based on the type of the qubit. Different types of qubits have different properties, so the model types and the model parameters for predicting the decoherence time may be different. Therefore, the model types and the model parameters of the decoherence model are acquired according to the types of the qubits, and the accuracy of the decoherence model obtained subsequently may be improved.

In some embodiments, the model type is used for representing a model form to a certain extent; the model form may refer to a condition that the quantum state changes over time, for example, the model form may be a function form that the probability of the quantum state changes over time, such as an exponential form or a double-exponential form. The model parameters are used for representing parameters influencing the decoherence time of the qubit to a certain extent, for example, the model parameters may include natural property information of the qubit, and environment information of the qubit. The property information is represented by property parameters, and may include: manufacturing material parameters of the qubit, construction parameters of the qubit and the like; and the environment information is represented by environment parameters, and may include: magnetic flux bias amount of the qubit, environment temperature of the qubit and the like.

In some embodiments, the plurality of model types above may be of various function forms, and the plurality of model parameters above may be a plurality of combinations of different parameters, for example, a combination formed by different parameter values.

In some embodiments, acquiring a plurality of model types, and a plurality of model parameters includes: in a case that the decoherence measurement includes the depolarization measurement or the dephasing measurement, determining that the plurality of model types include an exponential type and a double exponential type corresponding to the depolarization measurement, and an exponential type and a Gaussian type corresponding to the dephasing measurement; and determining that the plurality of model parameters include property parameters of the qubit and environment parameters.

In some embodiments, during determining the plurality of type-parameter combinations based on the plurality of model types and the plurality of model parameters, the plurality of type-parameter combinations may be obtained based on any combination of the plurality of model types and the plurality of model parameters, for example, the plurality of type-parameter combinations may be obtained by combining any one of the plurality of model types with the plurality of model parameters. Therefore, the plurality of type-parameter combinations determined based on the plurality of model types and the plurality of model parameters may be N*M when the plurality of model types are N types and the plurality of model parameters are M types.

In step S206, the computer device determines candidate decoherence models corresponding to the plurality of type-parameter combinations based on the decoherence measurement data;

In some embodiments, determining candidate decoherence models corresponding to the plurality of type-parameter combinations based on the decoherence measurement data includes: for any type-parameter combination in the plurality of type-parameter combinations, acquiring a target model type of the any type-parameter combination and a target model parameter; determining a value of the target model parameter under the target model type based on the decoherence measurement data, so as to obtain a candidate decoherence model corresponding to the any type-parameter combination; and obtaining the candidate decoherence models corresponding to the plurality of type-parameter combinations by a mode of obtaining the candidate decoherence model corresponding to the any type-parameter combination. With adoption of the mode above, the candidate decoherence models corresponding to the plurality of type-parameter combinations is determined, that is, there is a corresponding target model type and a value of the target model parameter in the any candidate decoherence model.

In some embodiments, determining a value of the target model parameter under the target model type based on the decoherence measurement data, so as to obtain a candidate decoherence model corresponding to the any type-parameter combination includes: determining corresponding quantum states of the qubit at a plurality of time points based on the decoherence measurement data; based on the plurality of time points and the corresponding quantum states of the qubit at the plurality of time points, fitting a coherence curve; and determining a value of the target model parameter under the target model type based on the coherence curve, so as to obtain the candidate decoherence model corresponding to the any type-parameter combination. With adoption of the mode of curve fitting above, the candidate decoherence model may be accurately determined based on a mathematical model representation mode.

In step S208, the computer device determines a target decoherence model from the candidate decoherence models corresponding to the plurality of type-parameter combinations.

In some embodiments, a plurality of models may be adopted during determining the target decoherence model from the candidate decoherence models corresponding to the plurality of type-parameter combinations, for example, a mode of optimizing the plurality of candidate decoherence models, and then determining the target decoherence model based on the optimization result.

In some embodiments, acquiring decoherence measurement data obtained by performing decoherence measurement on the qubit includes; acquiring experimental measurement data from a decoherence measurement experiment on an experimental qubit; predicting a decoherence data of the experimental qubit by the candidate decoherence models corresponding to the plurality of type-parameter combinations respectively, so as to obtain corresponding prediction data; comparing the experimental measurement data with the prediction data of the candidate decoherence models corresponding to the plurality of type-parameter combinations respectively, so as to obtain comparison difference results; and selecting the candidate decoherence model with a minimum difference result from the comparison difference results as the target decoherence model. On the basis of the comparison between the prediction data and the real experimental measurement data, the candidate decoherence model with good optimization result is obtained, and can be used as the target decoherence model.

In some embodiments, in order to make the obtained decoherence model more accurate, the data obtained from decoherence measurement may be corrected before being processed, for example, determining corresponding quantum states of the qubit at a plurality of time points based on the decoherence measurement data includes: correcting the decoherence measurement data to obtain corrected data; and determining the candidate decoherence models corresponding to the plurality of type-parameter combinations based on the corrected data.

In some embodiments, after determining a target decoherence model from the candidate decoherence models corresponding to the plurality of type-parameter combinations, the method further includes: predicting a to-be-measured qubit by the target decoherence model, so as to obtain a decoherence time of the to-be-measured qubit. The obtained original target decoherence model is adopted to predict the qubit to obtain the decoherence time of the qubit so as to assist in measurement of the qubit.

In some embodiments of the present disclosure, the method includes: acquiring the decoherence measurement data obtained by performing decoherence measurement on the qubit, and determining the candidate decoherence models corresponding to the plurality of type parameter combines based on the decoherence measurement data; and determining the target decoherence model from the candidate decoherence models corresponding to the plurality of type-parameter combinations, so the effects of reversely deducing model parameters the decoherence models (namely, the plurality of candidate decoherence models) based on the decoherence measurement data, and selecting the target decoherence model from the plurality of candidate decoherence models are achieved; real and accurate decoherence measurement data, rather than a plurality of purely theoretical model parameters, is adopted in determining the plurality of candidate decoherence models, so that the accuracy of obtaining the decoherence model is effectively improved; and in addition, the target decoherence model is selected from the plurality of candidate decoherence models, thus the decoherence model is further optimized, then the obtained target decoherence model is more optimized and accurate, and as a result, the technical problem of the technical problem of low efficiency in initializing the qubit in conventional technology is solved.

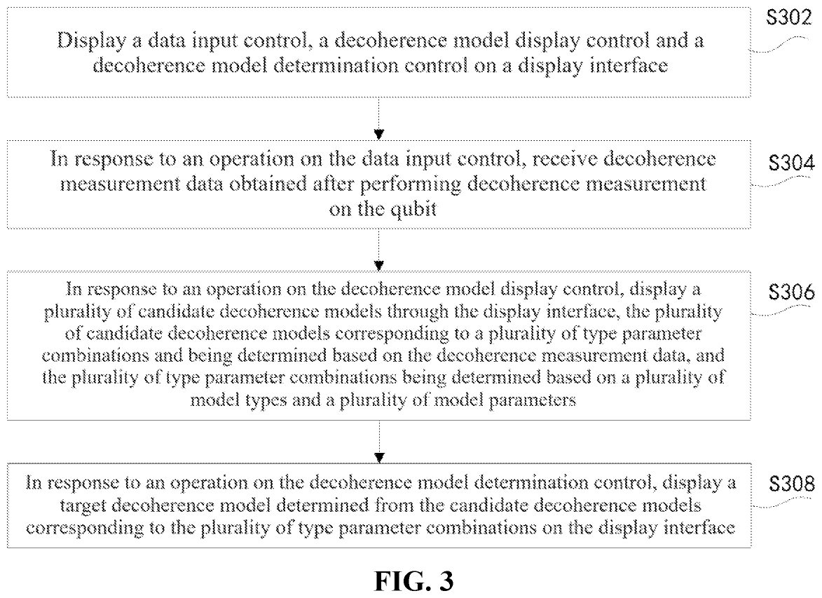

FIG. 3 is a flowchart of an example method for determining a decoherence model of a qubit, according to some embodiments of the present disclosure. As shown in FIG. 3, the method may include the following steps S302 to S308. It is be noted that the steps shown in the flowchart of the accompanying drawings may be executed in a computer system such as a set of computer-executable instructions, and moreover, although a logical order is shown in the flowchart, in some cases, the steps shown or described may be performed in an order different from that shown or described herein.

In step S302, an apparatus (e.g., a computer device) displays a data input control, a decoherence model display control and a decoherence model determination control on a display interface;

In step S304, in response to an operation on the data input control, the apparatus receives decoherence measurement data obtained after performs decoherence measurement on the qubit;

In step S306, in response to an operation on the decoherence model display control, the apparatus displays a plurality of candidate decoherence models on the display interface, the plurality of candidate decoherence models corresponding to a plurality of type-parameter combinations and being determined based on the decoherence measurement data, and the plurality of type-parameter combinations being determined based on a plurality of model types and a plurality of model parameters; and

In step S308, in response to an operation on the decoherence model determination control, the apparatus displays a target decoherence model determined from the candidate decoherence models corresponding to the plurality of type-parameter combinations on the display interface.

In some embodiments of the present disclosure, the method includes: acquiring the decoherence measurement data obtained by performing decoherence measurement on the qubit based on the display interface for interaction, and determining the candidate decoherence models corresponding to the plurality of type-parameter combinations based on the decoherence measurement data; and determining the target decoherence model from the candidate decoherence models corresponding to the plurality of type-parameter combinations, so the effects of reversely deducing model parameters the decoherence models (namely, the plurality of candidate decoherence models) based on the decoherence measurement data, and selecting the target decoherence model from the plurality of candidate decoherence models are achieved; real and accurate decoherence measurement data, rather than a plurality of purely theoretical model parameters, is adopted in determining the plurality of candidate decoherence models, so that the accuracy of obtaining the decoherence model is effectively improved; and in addition, the target decoherence model is selected from the plurality of candidate decoherence models, thus the decoherence model is further optimized, then the obtained target decoherence model is more optimized and accurate, and as a result, the technical problem of the technical problem of low efficiency in initializing the qubit in conventional technology is solved. Through the above processing, the display interface is adopted to display the whole determination process of the decoherence model, so that the visualization of the process is realized, and the effect of improving the user experience is achieved.

In some embodiments, the decoherence model may predict the decoherence time of the qubit under a specific condition after a plurality of decoherence parameters are specified. A guidance may be provided for improving the qubit. In conventional technologies, various different decoherence models can be adopted to predict the decoherence time, which is verified in different experiments. However, no unified software program is used for obtaining the decoherence measurement model from the decoherence measurement data at present. In some embodiment, the decoherence measurement data is processed, namely model parameters of the decoherence model are reversely deduced from the decoherence measurement data; and due to the participation of real experimental data, an accurate decoherence model can be obtained.

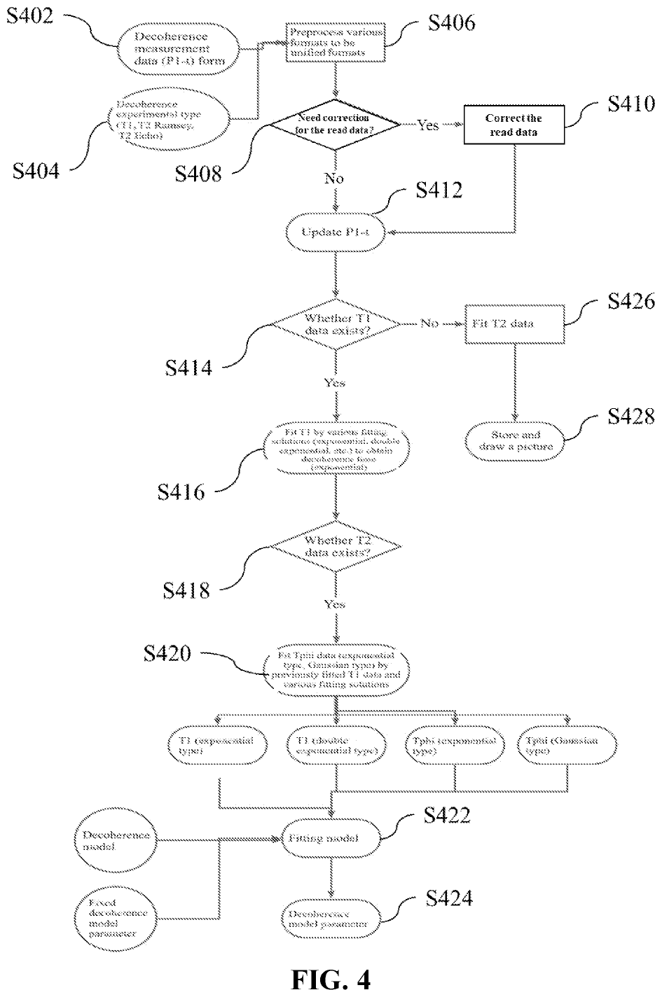

FIG. 4 is a flowchart of an example method for determining a decoherence model, according to some embodiment of the present disclosure. It is be noted that the steps shown in the flowchart of the accompanying drawings may be executed in a computer system such as a set of computer-executable instructions, and moreover, although a logical order is shown in the flowchart, in some cases, the steps shown or described may be performed in an order different from that shown or described herein. As shown in FIG. 4, the flow includes the following step S402 to S428, which can be implemented by a data processing device (e.g., computer terminal 10 in FIG. 1).

In a general decoherence model, the qubit has two measurable decoherence times, namely T1 (depolarization) and T2 (dephasing). Tphi refers to pure dephasing time (the influence of T1 is removed from T2). In some embodiment of the present disclosure, that the decoherence measurement performed on the qubit includes T1 type measurement and T2 type measurement is taken as an example for description.

T1 type measurement can be performed on the qubit to obtain 1-state occupation numbers (P1) of the qubit at different time points (t) in a specific initial state. The measured data is provided as decoherence measurement data P1-t form, which can be obtained by the data processing device in step S402.

In addition, T2 type measurement can be performed on the qubit to obtain 1-state occupation numbers of the qubit at different time points (t) after quantum gate operation of specific phase change at the beginning and the end, which can be obtained by the data processing device in step S402, as well.

In step S404, the data processing device may obtain experimental measurement data from a decoherence experiment (e.g., T1, T2 Ramsey, and T2 Echo). After that, the data processing device can pre-process various formats to be unified formats in step S406.

In step S408, the data processing device determines whether a correction for the read data is needed. The data processing device can selectively correct the occupation numbers according to a reading solution of the occupation numbers in step S410 if it is determined to correct the read data. It is to be noted that steps S408 and S410 are optional, and the processed occupation numbers may be used for estimating the effective temperature of the system. If the occupation numbers are not processed, only the relative value of the occupation numbers is valid, and the effective temperature of the system is to be additionally measured from another way.

Whether or not a correction is applied to the read data, the data processing device can update P1-t in step S412. The data processing device can fit P1-t (namely a relationship curve of P1 changing with time t) of T1 by an exponential function to obtain exponential type T1based on the following function: y=exp(−a*t). Similarly, a double exponential function is adopted to fit to obtain a double exponential type T1 based on the following function: y=exp(a*(exp(−t*b)−1))*exp(−t/c). The qubit may better conform to one of the functions under different conditions.

In step S414, the data processing device determines whether T1 data exists or not. If T1 data does not exist, the process goes to step S426 in which T2 data can be fitted. Specifically, the data processing device can fit P1-t of T2 by using an exponential function or a Gaussian function +T1 under a condition that T1 is known, so as to obtain a corresponding type of Tphi. The qubit may better conform to one of the functions under different conditions. Then, in step S428, the data is stored by the data processing device and a picture can be drawn accordingly.

In step S416, the data processing device can fit T1 by various fitting solutions (e.g., exponential, double exponential, etc.) to obtain decoherence time (exponential). Then, the data processing device determines whether T2 data exists in step S418. If the data processing device determines that T2 data exists, the process goes to step S420, in which Tphi data (e.g., exponential type, Gaussian type) can be fitted by previously fitted T1 data and various fitting solutions. As such, the data processing device calculates T1 or Tphi of the qubit under a condition that the model and model parameters are given. The model determines which type T1 or Tphi belongs to (exponential/double exponential, exponential/Gaussian). It is to be noted that different models may share the same model parameters.

In step S422, the model can be fitted. The data processing device can select the model and the model parameters to be solved by a user, and optimize the difference between the model parameters and T1 or Tphi obtained according to experimental data through an optimization algorithm to obtain optimal model parameters. As mentioned above, the experimental data is obtained in step S404, which may include T1, T2 Ramsey, and T2 Echo.

In step S424, decoherence mode parameters can be determined. The data processing device can output optimization results of various models and parameters and the difference between the optimized model and an experiment, and determine which model is the optimal model.

In some embodiments of the present disclosure, the model parameters of the decoherence model are reversely deduced based on the experimental data, then the optimal decoherence model is obtained, and thus a basis is provided for accurate qubit measurement.

It is to be noted that for the foregoing method embodiments, for the sake of simple description, they are expressed as a series of action combinations, but it is appreciated that the present disclosure is not limited by the described action sequence. According to the present disclosure, certain steps may be performed in other orders or simultaneously. Secondly, it is appreciated that the embodiments described in the specification belong to preferred embodiments, and the actions and modules involved are not necessarily required by the present disclosure.

Through the description of the above embodiments, it is appreciated that the method according to the above embodiments can be realized by means of software and a necessary universal hardware platform, and definitely, the method can also be realized through hardware, but the former is a preferred embodiment in many cases. Based on this understanding, the technical solution of the present disclosure can be embodied in the form of a software product in essence or a part contributing to the conventional technology. The computer software product is stored in a computer readable storage medium (such as an ROM/RAM, a magnetic disk and an optical disk), and includes a plurality of instructions for enabling a terminal device (which can be a mobile phone, a computer, a server or network equipment and the like) to execute the methods of the embodiments of the present disclosure.

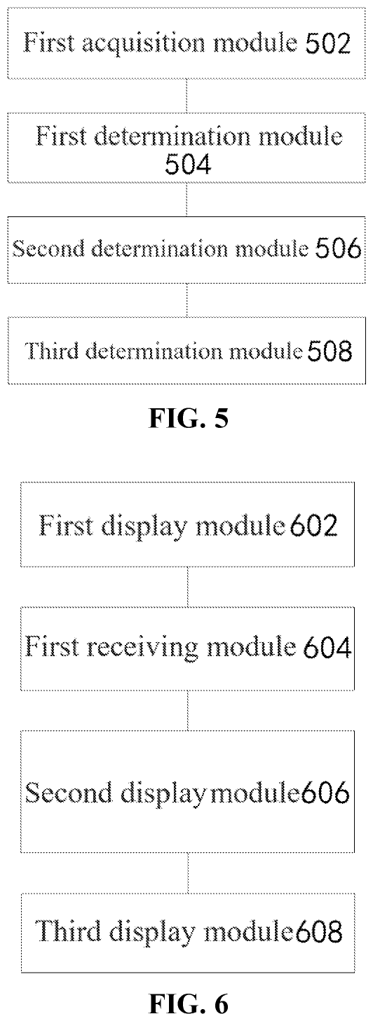

FIG. 5 is a frame diagram of an example apparatus for determining a decoherence model of a qubit, according to some embodiments of the present disclosure. As shown in FIG. 5, the apparatus includes: a first acquisition module 502, a first determination module 504, a second determination module 506, and a third determination module 508.

The first acquisition module 502 is configured to acquire decoherence measurement data obtained by performing decoherence measurement on the qubit; the first determination module 504 is connected to the first acquisition module 502, and is configured to determine a plurality of type-parameter combinations, the type-parameter combinations being combinations of model types and model parameters; the second determination module 506 is connected to the abovementioned first determination module 504, and is configured to determine candidate decoherence models corresponding to the plurality of type-parameter combinations based on the decoherence measurement data; and the third determination module 508 is connected to the abovementioned second determination module 506, and is configured to determine a target decoherence model from the candidate decoherence models corresponding to the plurality of type-parameter combinations.

It is to be noted that the first acquisition module 502, the first determination module 504, the second determination module 506 and the third determination module 508 correspond to steps S202-S208 described above, respectively; the modules and the corresponding steps have the same examples and application scenarios, which are not limited to those disclosed above. It is to be noted that the modules may run in a computer terminal 10 provided above as part of the apparatus.

FIG. 6 is a frame diagram of an example apparatus for determining a decoherence model of a qubit, according to some embodiments of the present disclosure. As shown in FIG. 6, the apparatus includes: a first display module 602, a first receiving module 604, a second display module 606 and a third display module 608.

The first display module 602 is configured to display a data input control, a decoherence model display control and a decoherence model determination control on a display interface; the first receiving module 604 is connected to the first display module 602, and is configured to: in response to an operation on the data input control, receive decoherence measurement data obtained after performing decoherence measurement on the qubit; the second display module 606 is connected to the first receiving module 604, and is configured to, in response to an operation on the decoherence model display control, display a plurality of candidate decoherence models on the display interface, the plurality of candidate decoherence models corresponding to a plurality of type-parameter combinations and being determined based on the decoherence measurement data, and the plurality of type-parameter combinations being determined based on a plurality of model types and a plurality of model parameters; and the third display module 608 is connected to the second display module 606, and is configured to, in response to an operation on the decoherence model determination control, display a target decoherence model determined from the candidate decoherence models corresponding to the plurality of type-parameter combinations on the display interface.

It is to be noted that the first display module 602, the first receiving module 604, the second display module 606 and the third display module 608 correspond to steps S302-S308 described above, respectively; and the modules are the same as examples and application scenes realized by the corresponding steps, but are not limited to the content disclosed above. It is to be noted that the modules may run in a computer terminal 10 provided above as part of the apparatus.

An embodiment of the present disclosure further provides a computer readable storage medium. In some embodiments, the computer readable storage medium may be used for storing program codes executed by the method for determining the decoherence model of the qubit provided above.

In some embodiments, the computer readable storage medium may be in any computer terminal in a computer terminal group in a computer network, or in any mobile terminal in a mobile terminal group.

In some embodiments, the computer readable storage medium is set to store program codes for executing the following steps: acquiring decoherence measurement data obtained by performing decoherence measurement on the qubit; determining a plurality of type-parameter combinations, the type-parameter combinations being combinations of model types and model parameters; determining candidate decoherence models corresponding to the plurality of type-parameter combinations based on the decoherence measurement data; and determining a target decoherence model from the candidate decoherence models corresponding to the plurality of type-parameter combinations.

In some embodiments, the computer readable storage medium is further set to store program codes for executing the following steps: acquiring decoherence measurement data obtained by performing decoherence measurement on the qubit, including: in a case that the decoherence measurement includes depolarization measurement or dephasing measurement, acquiring depolarization measurement data obtained by performing depolarization measurement on the qubit; or acquiring dephasing measurement data obtained by performing dephasing measurement on the qubit, the decoherence measurement data including the depolarization measurement data or the dephasing measurement data.

In some embodiments, the computer readable storage medium is further set to store program codes for executing the following steps: acquiring a plurality of model types, and a plurality of model parameters, including: in a case that the decoherence measurement includes the depolarization measurement or the dephasing measurement, determining that the plurality of model types comprise an exponential type and a double exponential type corresponding to the depolarization measurement, and an exponential type and a Gaussian type corresponding to the dephasing measurement; and determining that the plurality of model parameters include property parameters of the qubit and environment parameters.

In some embodiments, the computer readable storage medium is further set to store program codes for executing the following steps: determining a plurality of type-parameter combinations, including: acquiring a plurality of model types, and a plurality of model parameters; and combining the plurality of model types and the plurality of model parameters to obtain the plurality of type-parameter combinations.

In some embodiments, the computer readable storage medium is further set to store program codes for executing the following steps: acquiring a plurality of model types, and a plurality of model parameters, including: acquiring the type of the qubit; and acquiring the plurality of model types and the plurality of model parameters based on the type of the qubit.

In some embodiments, the computer readable storage medium is further set to store program codes for executing the following steps: determining candidate decoherence models corresponding to the plurality of type-parameter combinations based on the decoherence measurement data, including: for any type-parameter combination in the plurality of type-parameter combinations, acquiring a target model type of the any type-parameter combination and a target model parameter; determining a value of the target model parameter under the target model type based on the decoherence measurement data, so as to obtain a candidate decoherence model corresponding to the any type-parameter combination; and obtaining the candidate decoherence models corresponding to the plurality of type-parameter combinations by a mode of obtaining the candidate decoherence model corresponding to the any type-parameter combination.

In some embodiments, the computer readable storage medium is further set to store program codes for executing the following steps: determining a value of the target model parameter under the target model type based on the decoherence measurement data, so as to obtain a candidate decoherence model corresponding to the any type-parameter combination, including: determining corresponding quantum states of the qubit at a plurality of time points based on the decoherence measurement data; based on the plurality of time points and the corresponding quantum states of the qubit at the plurality of time points, fitting a coherence curve; and determining a value of the target model parameter under the target model type based on the coherence curve, so as to obtain the candidate decoherence model corresponding to the any type-parameter combination.

In some embodiments, the computer readable storage medium is further set to store program codes for executing the following steps: determining corresponding quantum states of the qubit at a plurality of time points based on the decoherence measurement data, including: correcting the decoherence measurement data to obtain corrected data; and determining the candidate decoherence models corresponding to the plurality of type-parameter combinations based on the corrected data.

In some embodiments, the computer readable storage medium is further set to store program codes for executing the following steps: determining a target decoherence model from the candidate decoherence models corresponding to the plurality of type-parameter combinations, including: acquiring experimental measurement data from a decoherence measurement experiment on an experimental qubit; predicting a decoherence data of the experimental qubit by the candidate decoherence models corresponding to the plurality of type-parameter combinations respectively, so as to obtain corresponding prediction data; comparing the experimental measurement data with the prediction data of the candidate decoherence models corresponding to the plurality of type-parameter combinations respectively, so as to obtain comparison difference results; and selecting the candidate decoherence model with a minimum difference result from the comparison difference results as the target decoherence model.

In some embodiments, the computer readable storage medium is further set to store program codes for executing the following steps: the qubit includes a Fluxonium qubit.

In some embodiments, the computer readable storage medium is further set to store program codes for executing the following steps: after determining a target decoherence model from the candidate decoherence models corresponding to the plurality of type-parameter combinations, the method further includes: predicting a to-be-measured qubit by the target decoherence model, so as to obtain a decoherence time of the to-be-measured qubit.

In some embodiments, the computer readable storage medium is further set to store program codes for executing the following steps: displaying a data input control, a decoherence model display control and a decoherence model determination control on a display interface; in response to an operation on the data input control, receiving decoherence measurement data obtained after performing decoherence measurement on the qubit; in response to an operation on the decoherence model display control, displaying a plurality of candidate decoherence models on the display interface, the plurality of candidate decoherence models corresponding to a plurality of type-parameter combinations and being determined based on the decoherence measurement data, and the plurality of type-parameter combinations being determined based on a plurality of model types and a plurality of model parameters; and in response to an operation on the decoherence model determination control, displaying a target decoherence model determined from the candidate decoherence models corresponding to the plurality of type-parameter combinations on the display interface.

An embodiment of the present disclosure may provide a computer device, and the computer device may be any computer terminal device in a computer terminal group. In some embodiments, the computer terminal may also be replaced with a terminal device such as a mobile terminal.

In some embodiments, the foregoing computer device may be located in at least one of a plurality of network devices of the computer network.

In some embodiments, the computer device may execute the program codes for executing the following steps in the method for determining the decoherence model of the qubit in the application program: acquiring decoherence measurement data obtained by performing decoherence measurement on the qubit; determining a plurality of type-parameter combinations, the type-parameter combinations being combinations of model types and model parameters; determining candidate decoherence models corresponding to the plurality of type-parameter combinations based on the decoherence measurement data; and determining a target decoherence model from the candidate decoherence models corresponding to the plurality of type-parameter combinations.

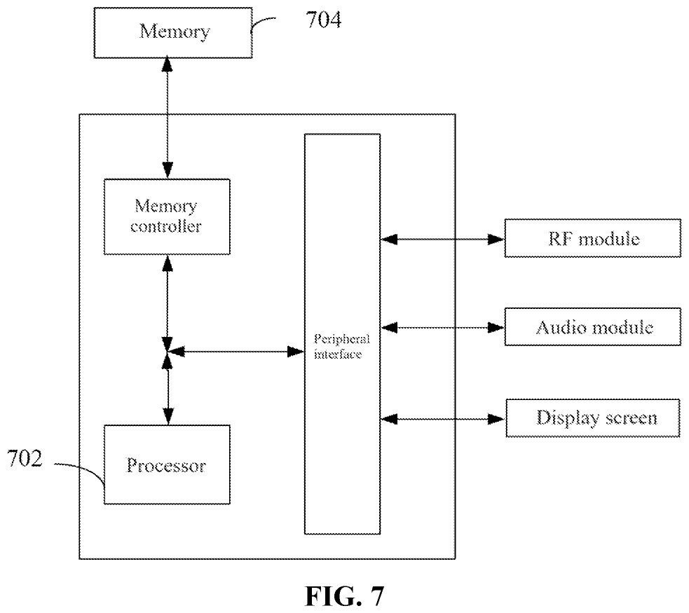

FIG. 7 is a structure block diagram of an example computer device, according to some embodiments of the present disclosure. As shown in FIG. 7, the computer device may include: one or more (only one shown in the figure) processors 702 (such as a CPU, microprocessor MCU or a programmable logic device FPGA, an ASIC, a GPU, an NPU, or other data processing circuitry), a memory 704, etc. Some of other components are shown in the figure, wherein a memory controller is used for control memory 704, a peripheral interface providing the accessibility to RF module, audio module, and display screen.

The memory 704 can be configured to store software programs and modules, such as a program instruction/module corresponding to the searching method and apparatus according to the embodiment of the present disclosure; and the processor 702 executes various function applications and data processing by running the software programs and the modules stored in the memory 704, namely, the abovementioned searching processing method is achieved. The memory 704 can include a high-speed random access memory 704 and may also include a nonvolatile memory 704, such as one or more magnetic storage apparatuses, flash memories or other nonvolatile solid-state memories 704. In the disclosed embodiments, the memory 704 can further include memories 704 remotely arranged relative to the processor 702, and the remote memories 704 may be connected to the computer terminal through a network. The examples of the network include but are not limited to the Internet, an intranet, a local area network, a mobile communication network and a combination thereof.

The processor 702 may be configured to call information and application program stored in the memory 704 through a transmission apparatus, so as to execute the following steps: acquiring decoherence measurement data obtained by performing decoherence measurement on the qubit; determining a plurality of type-parameter combinations, the type-parameter combinations being combinations of model types and model parameters; determining candidate decoherence models corresponding to the plurality of type-parameter combinations based on the decoherence measurement data; and determining a target decoherence model from the candidate decoherence models corresponding to the plurality of type-parameter combinations.

The processor 702 may also be configured to call information and application program stored in the memory 704 through the transmission apparatus, so as to execute the following steps: acquiring decoherence measurement data obtained by performing decoherence measurement on the qubit, including: in a case that the decoherence measurement includes depolarization measurement or dephasing measurement, acquiring depolarization measurement data obtained by performing depolarization measurement on the qubit; or acquiring dephasing measurement data obtained by performing dephasing measurement on the qubit, the decoherence measurement data including the depolarization measurement data or the dephasing measurement data.

The processor 702 may also be configured to call information and application program stored in the memory 704 through the transmission apparatus, so as to execute the following steps: acquiring a plurality of model types, and a plurality of model parameters, including: in a case that the decoherence measurement includes the depolarization measurement or the dephasing measurement, determining that the plurality of model types include an exponential type and a double exponential type corresponding to the depolarization measurement, and an exponential type and a Gaussian type corresponding to the dephasing measurement; and determining that the plurality of model parameters include property parameters of the qubit and environment parameters.

The processor 702 may also be configured to call information and application program stored in the memory 704 through the transmission apparatus, so as to execute the following steps: determining a plurality of type-parameter combinations, including: acquiring a plurality of model types, and a plurality of model parameters; and combining the plurality of model types and the plurality of model parameters to obtain the plurality of type-parameter combinations.

The processor 702 may also be configured to call information and application program stored in the memory 704 through the transmission apparatus, so as to execute the following steps: acquiring a plurality of model types, and a plurality of model parameters, including: acquiring the type of the qubit; and acquiring the plurality of model types and the plurality of model parameters based on the type of the qubit.

The processor 702 may also be configured to call information and application program stored in the memory 704 through the transmission apparatus, so as to execute the following steps: determining candidate decoherence models corresponding to the plurality of type-parameter combinations based on the decoherence measurement data, including: for any type-parameter combination in the plurality of type-parameter combinations, acquiring a target model type of the any type-parameter combination and a target model parameter; determining a value of the target model parameter under the target model type based on the decoherence measurement data, so as to obtain a candidate decoherence model corresponding to the any type-parameter combination; and obtaining the candidate decoherence models corresponding to the plurality of type-parameter combinations by a mode of obtaining the candidate decoherence model corresponding to the any type-parameter combination.

The processor 702 may also be configured to call information and application program stored in the memory 704 through the transmission apparatus, so as to execute the following steps: determining a value of the target model parameter under the target model type based on the decoherence measurement data, so as to obtain a candidate decoherence model corresponding to the any type-parameter combination, including: determining corresponding quantum states of the qubit at a plurality of time points based on the decoherence measurement data; based on the plurality of time points and the corresponding quantum states of the qubit at the plurality of time points, fitting a coherence curve; and determining a value of the target model parameter under the target model type based on the coherence curve, so as to obtain the candidate decoherence model corresponding to the any type-parameter combination.

The processor 702 may also be configured to call information and application program stored in the memory 704 through the transmission apparatus, so as to execute the following steps: determining corresponding quantum states of the qubit at a plurality of time points based on the decoherence measurement data, including: correcting the decoherence measurement data to obtain corrected data; and determining the candidate decoherence models corresponding to the plurality of type-parameter combinations based on the corrected data.

The processor 702 may also be configured to call information and application program stored in the memory 704 through the transmission apparatus, so as to execute the following steps: determining a target decoherence model from the candidate decoherence models corresponding to the plurality of type-parameter combinations, including: acquiring experimental measurement data from a decoherence measurement experiment on an experimental qubit; predicting a decoherence data of the experimental qubit by the candidate decoherence models corresponding to the plurality of type-parameter combinations respectively, so as to obtain corresponding prediction data; comparing the experimental measurement data with the prediction data of the candidate decoherence models corresponding to the plurality of type-parameter combinations respectively, so as to obtain comparison difference results; and selecting the candidate decoherence model with a minimum difference result from the comparison difference results as the target decoherence model.

The processor 702 may also be configured to call information and application program stored in the memory 704 through the transmission apparatus, so as to execute the following steps: the qubit includes a Fluxonium qubit.

The processor 702 may also be configured to call information and application program stored in the memory 704 through the transmission apparatus, so as to execute the following steps: after determining a target decoherence model from the candidate decoherence models corresponding to the plurality of type-parameter combinations, the method further includes: predicting a to-be-measured qubit by the target decoherence model, so as to obtain a decoherence time of the to-be-measured qubit.

The processor 702 may also be configured to call information and application program stored in the memory 704 through the transmission apparatus, so as to execute the following steps: displaying a data input control, a decoherence model display control and a decoherence model determination control on a display interface; in response to an operation on the data input control, receiving decoherence measurement data obtained after performing decoherence measurement on the qubit; in response to an operation on the decoherence model display control, displaying a plurality of candidate decoherence models on the display interface, the plurality of candidate decoherence models corresponding to a plurality of type-parameter combinations and being determined based on the decoherence measurement data, and the plurality of type-parameter combinations being determined based on a plurality of model types and a plurality of model parameters; and in response to an operation on the decoherence model determination control, displaying a target decoherence model determined from the candidate decoherence models corresponding to the plurality of type-parameter combinations on the display interface.

It is appreciated that, the structure shown in FIG. 7 is only schematic, and the computer terminal e may be a terminal device such as a smart phone (like an Android mobile phone or an iOS mobile phone), a tablet computer, a palmtop computer, Mobile Internet Devices (MIDs), or a PAD. FIG. 7 does not constitute a limitation on a structure of the foregoing electronic apparatus. For example, the computer terminal may further include more or less assemblies than those shown in FIG. 7, or has different configurations from those shown in FIG. 7.

It can be appreciated that all or part of the steps in the various methods of the above embodiments may be completed by instructing the hardware related to the terminal device through a program. The program may be stored in a computer readable storage medium, and the computer readable storage medium may include: a flash disk, a Read-Only Memory (ROM), a Random Access Memory (RAM), a magnetic disk or an optical disk, and the like.

The serial numbers of the above embodiments of the present disclosure are for description only, and do not represent the advantages and disadvantages of the embodiments.

In the above-mentioned embodiments of the present disclosure, the descriptions of each embodiment have their own emphases, and for parts not described in detail in a certain embodiment, reference may be made to relevant descriptions of other embodiments.

In the several embodiments provided in this application, it is to be understood that, the disclosed technical content may be implemented in another manner. The apparatus embodiments described above are merely exemplary. For example, the division of the units is merely the division of logic functions, and may use other division manners during actual implementation. For example, a plurality of units or components may be combined, or may be integrated into another system, or some features may be omitted or not performed. In addition, the coupling, or direct coupling, or communication connection between the displayed or discussed components may be the indirect coupling or communication connection by means of some interfaces, units, or modules, and may be electrical or of other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the embodiments.

In addition, each functional unit in each embodiment of the present disclosure may be integrated into one processing unit, each unit may exist separately physically, or two or more units may be integrated into one unit. The integrated unit may be implemented in the form of hardware, or may be implemented in a form of a software functional unit.

When the integrated unit is implemented in a form of a software functional unit and sold or used as an independent product, the integrated unit may be stored in one computer readable storage medium. Based on such an understanding, the technical solutions of the present disclosure essentially, or a part contributing to the related art, or all or a part of the technical solution may be implemented in a form of a software product. computer software product is stored in a computer readable storage medium and includes several instructions for instructing one computer device (which may be a PC, a server, a network device or the like) to perform all or some of steps of the methods in the embodiments of the present disclosure. The abovementioned computer readable storage medium includes: a U disk, a Read-Only Memory (ROM), a Random Access Memory (RAM), a mobile hard disk, a disk or an optical disc and other media that may store program codes.

The embodiments may further be described using the following clauses:
1. A method for determining a decoherence model of a qubit, including:
acquiring decoherence measurement data obtained by performing decoherence measurement on the qubit;
determining a plurality of type-parameter combinations that includes combinations of model types and model parameters;
determining candidate decoherence models corresponding to the plurality of type-parameter combinations based on the decoherence measurement data; and
determining a target decoherence model from the candidate decoherence models corresponding to the plurality of type-parameter combinations.
2. The method according to clause 1, wherein acquiring the decoherence measurement data obtained by performing the decoherence measurement on the qubit includes:
when the decoherence measurement includes depolarization measurement or dephasing measurement, performing depolarization measurement on the qubit to obtain depolarization measurement data; or performing dephasing measurement on the qubit to obtain dephasing measurement data, wherein the decoherence measurement data including the depolarization measurement data or the dephasing measurement data.
3. The method according to clause 2, wherein determining the plurality of type-parameter combinations being the combinations of the model types and the model parameters includes:
when the decoherence measurement includes the depolarization measurement and the dephasing measurement, determining that the model types include an exponential type and a double exponential type corresponding to the depolarization measurement, and an exponential type and a Gaussian type corresponding to the dephasing measurement; and
determining that the model parameters include property parameters of the qubit and environment parameters.
4. The method according to any of clauses 1 to 3, wherein determining the plurality of type-parameter combinations being the combinations of the model types and the model parameters includes:
acquiring a plurality of model types, and a plurality of model parameters; and
combining the plurality of model types and the plurality of model parameters to obtain the plurality of type-parameter combinations.
5. The method according to clause 4, wherein determining the plurality of type-parameter combinations being combinations of the model types and the model parameters includes: acquiring a type of the qubit; and acquiring the plurality of model types and the plurality of model parameters based on the type of the qubit.
6. The method according to any of clauses 1 to 5, wherein determining the candidate decoherence models corresponding to the plurality of type-parameter combinations based on the decoherence measurement data includes:
for any type-parameter combination in the plurality of type-parameter combinations, acquiring a target model type and a target model parameter of the any type-parameter combination;
determining a value of the target model parameter under the target model type based on the decoherence measurement data, so as to obtain a candidate decoherence model corresponding to the any type-parameter combination; and
obtaining the candidate decoherence models corresponding to the plurality of type-parameter combinations by a mode of obtaining the candidate decoherence model corresponding to the any type-parameter combination.
7. The method according to clause 6, wherein determining the value of the target model parameter under the target model type based on the decoherence measurement data includes:
determining corresponding quantum states of the qubit at a plurality of time points based on the decoherence measurement data;
fitting a coherence curve based on the plurality of time points and the corresponding quantum states of the qubit at the plurality of time points; and
determining the value of the target model parameter under the target model type based on the coherence curve, so as to obtain the candidate decoherence model corresponding to the any type-parameter combination.
8. The method according to clause 7, wherein determining the corresponding quantum states of the qubit at the plurality of time points based on the decoherence measurement data includes:
correcting the decoherence measurement data to obtain corrected data; and
determining the candidate decoherence models corresponding to the plurality of type-parameter combinations based on the corrected data.
9. The method according to any of clauses 1 to 8, wherein determining the target decoherence model from the candidate decoherence models corresponding to the plurality of type-parameter combinations includes:
acquiring experimental measurement data from a decoherence measurement experiment on an experimental qubit;
predicting decoherence data of the experimental qubit by the candidate decoherence models corresponding to the plurality of type-parameter combinations respectively, so as to obtain corresponding prediction data;
comparing the experimental measurement data with the prediction data of the candidate decoherence models corresponding to the plurality of type-parameter combinations respectively, so as to obtain comparison difference results; and
selecting the candidate decoherence model with a minimum difference result from the comparison difference results as the target decoherence model.
10. The method according to any of clauses 1 to 9, wherein the qubit includes a Fluxonium qubit.
11. The method according to clause 9, further including:
predicting a to-be-measured qubit by the target decoherence model, so as to obtain a decoherence time of the to-be-measured qubit, after determining the target decoherence model from the candidate decoherence models corresponding to the plurality of type-parameter combinations.
12. A method for determining a decoherence model of a qubit, including:
displaying a data input control, a decoherence model display control and a decoherence model determination control on a display interface;
in response to an operation on the data input control, receiving decoherence measurement data obtained after performing decoherence measurement on the qubit;
in response to an operation on the decoherence model display control, displaying a plurality of candidate decoherence models on the display interface, the plurality of candidate decoherence models corresponding to a plurality of type-parameter combinations and being determined based on the decoherence measurement data, and the plurality of type-parameter combinations being determined based on a plurality of model types and a plurality of model parameters; and
in response to an operation on the decoherence model determination control, displaying a target decoherence model determined from the candidate decoherence models corresponding to the plurality of type-parameter combinations on the display interface.
13. A non-transitory computer readable storage medium, storing a set of instructions that are executable by one or more processors of a device to cause the device to perform operations for determining fidelity of a qubit gate in a quantum chip, the operations including:
acquiring decoherence measurement data obtained by performing decoherence measurement on the qubit;
determining a plurality of type-parameter combinations that includes combinations of model types and model parameters;
determining candidate decoherence models corresponding to the plurality of type-parameter combinations based on the decoherence measurement data; and
determining a target decoherence model from the candidate decoherence models corresponding to the plurality of type-parameter combinations.
14. The non-transitory computer readable storage medium according to clause 13, wherein acquiring the decoherence measurement data obtained by performing the decoherence measurement on the qubit includes:
when the decoherence measurement includes depolarization measurement or dephasing measurement, performing depolarization measurement on the qubit to obtain depolarization measurement data; or performing dephasing measurement on the qubit to obtain dephasing measurement data, wherein the decoherence measurement data includes the depolarization measurement data or the dephasing measurement data.
15. The non-transitory computer readable storage medium according to clause 14, wherein determining the plurality of type-parameter combinations that includes the combinations of the model types and the model parameters includes:
when the decoherence measurement includes the depolarization measurement and the dephasing measurement, determining that the model types include an exponential type and a double exponential type corresponding to the depolarization measurement, and an exponential type and a Gaussian type corresponding to the dephasing measurement; and
determining that the model parameters include property parameters of the qubit and environment parameters.
16. The non-transitory computer readable storage medium according to clause 13, wherein determining the plurality of type-parameter combinations that includes the combinations of the model types and the model parameters includes:
acquiring a plurality of model types, and a plurality of model parameters; and
combining the plurality of model types and the plurality of model parameters to obtain the plurality of type-parameter combinations.
17. The non-transitory computer readable storage medium according to clause 16, wherein determining the plurality of type-parameter combinations that includes combinations of the model types and the model parameters includes:
acquiring a type of the qubit; and
acquiring the plurality of model types and the plurality of model parameters based on the type of the qubit.
18. The non-transitory computer readable storage medium according to clause 13, wherein determining the candidate decoherence models corresponding to the plurality of type-parameter combinations based on the decoherence measurement data includes:
for any type-parameter combination in the plurality of type-parameter combinations, acquiring a target model type and a target model parameter of the any type-parameter combination;
determining a value of the target model parameter under the target model type based on the decoherence measurement data, so as to obtain a candidate decoherence model corresponding to the any type-parameter combination; and
obtaining the candidate decoherence models corresponding to the plurality of type-parameter combinations by a mode of obtaining the candidate decoherence model corresponding to the any type-parameter combination.
19. The non-transitory computer readable storage medium according to clause 18, wherein determining the value of the target model parameter under the target model type based on the decoherence measurement data includes:
determining corresponding quantum states of the qubit at a plurality of time points based on the decoherence measurement data;
fitting a coherence curve based on the plurality of time points and the corresponding quantum states of the qubit at the plurality of time points; and
determining the value of the target model parameter under the target model type based on the coherence curve, so as to obtain the candidate decoherence model corresponding to the any type-parameter combination.
20. A computer device for determining a decoherence model of a qubit, including:
a memory storing instructions; and
one or more processors configured to execute the instructions to cause the computer device to perform operations including:
   acquiring decoherence measurement data obtained by performing decoherence measurement on the qubit;
   determining a plurality of type-parameter combinations that includes combinations of model types and model parameters;
   determining candidate decoherence models corresponding to the plurality of type-parameter combinations based on the decoherence measurement data; and
   determining a target decoherence model from the candidate decoherence models corresponding to the plurality of type-parameter combinations.

It is to be noted that, the terms such as “first” and “second” in the specification and claims of this disclosure and the above accompanying drawings are used for distinguishing similar objects but not necessarily used for describing particular order or sequence. It is to be understood that such used data is interchangeable where appropriate so that the examples of this disclosure described here can be implemented in an order other than those illustrated or described here. Moreover, the terms “include”, “have” and any other variants thereof mean to cover the non-exclusive inclusion. For example, a process, method, system, product, or device that includes a list of steps or units is not necessarily limited to those expressly listed steps or units, but may include other steps or units not expressly listed or inherent to such a process, method, system, product, or device.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, it is appreciate that these steps can be performed in a different order while implementing the same method.

It should be understood that the disclosed technical content may be implemented in other ways. The apparatus embodiments described above are only schematic. For example, the division of the units is only a logical function division. In actual implementations, there may be another division manner. For example, multiple units or components may be combined or integrated into another system, or some features can be ignored or not implemented. In addition, the displayed or discussed mutual coupling or direct coupling or communication connection may be indirect coupling or communication connection through some interfaces, units, or modules, which may be in electrical or other forms.

The units described as separate components may or may not be physically separated, and the components displayed as units may or may not be physical units, that is, they may be located in one place or may be distributed to a plurality of network units. Part of or all the units may be selected according to actual needs to achieve the purpose of the solution of the present embodiment.

In addition, the functional units in various embodiments of the present disclosure may be integrated into one processing unit, or each unit may exist alone physically, or two or more units may be integrated into one unit. The integrated units described above may be implemented either in the form of hardware or in the form of a software functional unit.

If the integrated units are implemented in the form of a software functional unit and sold or used as an independent product, they may be stored in a quantum computer-readable storage medium. Based on such an understanding, the technical solutions of the present disclosure essentially, or the part making contributions to the prior art, or all or part of the technical solutions may be embodied in the form of a software product. The quantum computer software product is stored in a storage medium and includes several instructions used for causing a quantum computer device to execute all or part of steps of the methods in various embodiments of the present disclosure.

The foregoing descriptions are merely preferred implementations of this disclosure. It is to be noted that a plurality of improvements and refinements may be made by those of ordinary skill in the technical field without departing from the principle of this disclosure, and shall fall within the scope of protection of this disclosure.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for determining a decoherence model of a qubit, comprising:
acquiring decoherence measurement data obtained by performing decoherence measurement on the qubit;
determining a plurality of type-parameter combinations that includes combinations of model types and model parameters;
determining candidate decoherence models corresponding to the plurality of type-parameter combinations based on the decoherence measurement data; and
determining a target decoherence model from the candidate decoherence models corresponding to the plurality of types of parameter combinations.

2. The method according to claim 1, wherein acquiring the decoherence measurement data obtained by performing the decoherence measurement on the qubit comprises:
when the decoherence measurement comprises depolarization measurement or dephasing measurement, performing depolarization measurement on the qubit to obtain depolarization measurement data; or performing dephasing measurement on the qubit to obtain dephasing measurement data, wherein the decoherence measurement data comprises the depolarization measurement data or the dephasing measurement data.

3. The method according to claim 2, wherein determining the plurality of type-parameter combinations that includes the combinations of the model types and the model parameters comprises:
when the decoherence measurement comprises the depolarization measurement and the dephasing measurement, determining that the model types comprise an exponential type and a double exponential type corresponding to the depolarization measurement, and an exponential type and a Gaussian type corresponding to the dephasing measurement; and
determining that the model parameters comprise property parameters of the qubit and environment parameters.

4. The method according to claim 1, wherein determining the plurality of type-parameter combinations that includes combinations of the model types and the model parameters comprises:
acquiring a plurality of model types, and a plurality of model parameters; and
combining the plurality of model types and the plurality of model parameters to obtain the plurality of type-parameter combinations.

5. The method according to claim 4, wherein determining the plurality of type-parameter combinations that includes combinations of the model types and the model parameters comprises:
acquiring a type of the qubit; and
acquiring the plurality of model types and the plurality of model parameters based on the type of the qubit.

6. The method according to claim 1, wherein determining the candidate decoherence models corresponding to the plurality of type-parameter combinations based on the decoherence measurement data comprises:
for any type-parameter combination in the plurality of types of parameter combinations, acquiring a target model type and a target model parameter of the any type-parameter combination;
determining a value of the target model parameter under the target model type based on the decoherence measurement data, so as to obtain a candidate decoherence model corresponding to the any type-parameter combination; and
obtaining the candidate decoherence models corresponding to the plurality of type-parameter combinations by a mode of obtaining the candidate decoherence model corresponding to the any type-parameter combination.

7. The method according to claim 6, wherein determining the value of the target model parameter under the target model type based on the decoherence measurement data comprises:
determining corresponding quantum states of the qubit at a plurality of time points based on the decoherence measurement data;
fitting a coherence curve based on the plurality of time points and the corresponding quantum states of the qubit at the plurality of time points; and
determining the value of the target model parameter under the target model type based on the coherence curve, so as to obtain the candidate decoherence model corresponding to the any type-parameter combination.

8. The method according to claim 7, wherein determining the corresponding quantum states of the qubit at the plurality of time points based on the decoherence measurement data comprises:
correcting the decoherence measurement data to obtain corrected data; and
determining the candidate decoherence models corresponding to the plurality of type-parameter combinations based on the corrected data.

9. The method according to claim 1, wherein determining the target decoherence model from the candidate decoherence models corresponding to the plurality of type-parameter combinations comprises:
acquiring experimental measurement data from a decoherence measurement experiment on an experimental qubit;
predicting decoherence data of the experimental qubit by the candidate decoherence models corresponding to the plurality of type-parameter combinations respectively, so as to obtain corresponding prediction data;
comparing the experimental measurement data with the prediction data of the candidate decoherence models corresponding to the plurality of type-parameter combinations respectively, so as to obtain comparison difference results; and
selecting the candidate decoherence model with a minimum difference result from the comparison difference results as the target decoherence model.

10. The method according to claim 9, wherein the qubit comprises a Fluxonium qubit.

11. The method according to claim 9, further comprising:
predicting a to-be-measured qubit by the target decoherence model, so as to obtain a decoherence time of the to-be-measured qubit, after determining the target decoherence model from the candidate decoherence models corresponding to the plurality of type-parameter combinations.

12. A method for determining a decoherence model of a qubit, comprising:
displaying a data input control, a decoherence model display control and a decoherence model determination control on a display interface;
in response to an operation on the data input control, receiving decoherence measurement data obtained after performing decoherence measurement on the qubit;
in response to an operation on the decoherence model display control, displaying a plurality of candidate decoherence models on the display interface, the plurality of candidate decoherence models corresponding to a plurality of type-parameter combinations and being determined based on the decoherence measurement data, and the plurality of type-parameter combinations being determined based on a plurality of model types and a plurality of model parameters; and
in response to an operation on the decoherence model determination control, displaying a target decoherence model determined from the candidate decoherence models corresponding to the plurality of type-parameter combinations on the display interface.

13. A non-transitory computer readable storage medium, storing a set of instructions that are executable by one or more processors of a device to cause the device to perform operations for determining fidelity of a qubit gate in a quantum chip, the operations comprising:
acquiring decoherence measurement data obtained by performing decoherence measurement on the qubit;
determining a plurality of type-parameter combinations that includes combinations of model types and model parameters;
determining candidate decoherence models corresponding to the plurality of type-parameter combinations based on the decoherence measurement data; and
determining a target decoherence model from the candidate decoherence models corresponding to the plurality of type-parameter combinations.

14. The non-transitory computer readable storage medium according to claim 13, wherein acquiring the decoherence measurement data obtained by performing the decoherence measurement on the qubit comprises:
when the decoherence measurement comprises depolarization measurement or dephasing measurement, performing depolarization measurement on the qubit to obtain depolarization measurement data; or performing dephasing measurement on the qubit to obtain dephasing measurement data, wherein the decoherence measurement data comprises the depolarization measurement data or the dephasing measurement data.

15. The non-transitory computer readable storage medium according to claim 14, wherein determining the plurality of type-parameter combinations that includes the combinations of the model types and the model parameters comprises:
when the decoherence measurement comprises the depolarization measurement and the dephasing measurement, determining that the model types comprise an exponential type and a double exponential type corresponding to the depolarization measurement, and an exponential type and a Gaussian type corresponding to the dephasing measurement; and
determining that the model parameters comprise property parameters of the qubit and environment parameters.

16. The non-transitory computer readable storage medium according to claim 13, wherein determining the plurality of type-parameter combinations that includes the combinations of the model types and the model parameters comprises:
acquiring a plurality of model types, and a plurality of model parameters; and
combining the plurality of model types and the plurality of model parameters to obtain the plurality of type-parameter combinations.

17. The non-transitory computer readable storage medium according to claim 16, wherein determining the plurality of type-parameter combinations that includes combinations of the model types and the model parameters comprises:
acquiring a type of the qubit; and
acquiring the plurality of model types and the plurality of model parameters based on the type of the qubit.

18. The non-transitory computer readable storage medium according to claim 13, wherein determining the candidate decoherence models corresponding to the plurality of type-parameter combinations based on the decoherence measurement data comprises:
for any type-parameter combination in the plurality of type-parameter combinations, acquiring a target model type and a target model parameter of the any type-parameter combination;
determining a value of the target model parameter under the target model type based on the decoherence measurement data, so as to obtain a candidate decoherence model corresponding to the any type-parameter combination; and
obtaining the candidate decoherence models corresponding to the plurality of type-parameter combinations by a mode of obtaining the candidate decoherence model corresponding to the any type-parameter combination.

19. The non-transitory computer readable storage medium according to claim 18, wherein determining the value of the target model parameter under the target model type based on the decoherence measurement data comprises:
determining corresponding quantum states of the qubit at a plurality of time points based on the decoherence measurement data;
fitting a coherence curve based on the plurality of time points and the corresponding quantum states of the qubit at the plurality of time points; and
determining the value of the target model parameter under the target model type based on the coherence curve, so as to obtain the candidate decoherence model corresponding to the any type-parameter combination.

20. The non-transitory computer readable storage medium according to claim 19, wherein determining the corresponding quantum states of the qubit at the plurality of time points based on the decoherence measurement data comprises:
correcting the decoherence measurement data to obtain corrected data; and
determining the candidate decoherence models corresponding to the plurality of type-parameter combinations based on the corrected data.
